(19) United States
(12) Patent Application Publication
(10) Pub. No.: US 2002/0123307 A1
(43) Pub. Date: Sep. 5, 2002

(54) Wireless based system for managing the use of wireless communications and micoprocessor-based systems

(76) Inventor: Tyson Winarski, Tempe, AZ (US)

Correspondence Address: THE WINARSKI FIRM, P.L.L.C., 1265 EAST UNIVERSITY DRIVE, SUITE 3015, TEMPE, AZ, 85281, US

(21) Appl. No.: 09/798,593

(22) Filed: Mar. 3, 2001

(51) Int. Cl. H04B 5/00

(52) U.S. Cl. 455/41; 455/575

(57) ABSTRACT

A short-range wireless communications system is used to manage long-range wireless communications and microprocessor-based activity within its operating range. This management includes forbidding long-range wireless communications and microprocessor-based activity during certain times, with the possibility of allowing only emergency long-range wireless communications. This management also includes allowing long-range wireless communications and microprocessor-based activity during other times.

The short-range wireless communications system runs in parallel with the long-range wireless communications system. The short-range wireless communications system gives instructions to the microprocessor in the long-range wireless communications system and microprocessor-based activity as to whether the long-range wireless communications or microprocessor-based activity can continue or must be interrupted for a period of time. This management is limited by the range of the short-range wireless communications system, and is thus highly suitable for use in controlling long-range wireless communication and microprocessor-based activity by passengers in airplanes, patrons of theatres, diners in restaurants, attendees in business meeting rooms, and the like.

### FIELD OF THE INVENTION

The present invention generally relates to the field of the management of wireless communications and microprocessor-based technology via wireless communications. More specifically, the present invention relates to a wireless computer system that manages the permission to use wireless communications and microprocessor-based technology. Such permission is granted during normal operating periods and denied during other times.

### BACKGROUND

Wireless communications and microprocessor-based technology has had a major impact on the productivity of modem society. However, there are times when such technology is counterproductive or even dangerous. For example, airlines must manually prohibit the use of wireless cell phones, laptops, games, and other microprocessor-based technology by airline passengers during takeoffs and landings, so that the emissions of the wireless communications and microprocessor-based technology does not interfere with the navigational and instrumentation of the airplane. At other times, cell phones ring at inopportune times, such as dinners or theatrical productions. Additionally, wireless communications could freely broadcast the confidential content of proprietary business meetings.

The Bluetooth wireless technology allows users to make effortless, wireless and instant connections between various communication devices, such as mobile phones and desktop and notebook computers. Since it uses radio transmission, transfer of both voice and data is in real-time. The sophisticated mode of transmission adopted in the Bluetooth specification ensures protection from interference and security of data.

Currently, Bluetooth technology has a small maximum range, that of about 10 meters or 30 feet. Bluetooth currently operates in the 2.4 to 2.5 Gigahertz (GHz) Industrial-Scientific-Medical (ISM) frequency band, in which low-power radio transmitters are currently allowed to operate without first getting a United States government license. To avoid interference with other devices, Bluetooth currently hops around frequencies at a rate of 1,600 times a second. These characteristics make Bluetooth ideal for controlling wireless communication devices and microprocessor based computers within an aircraft, a restaurant, a theatre, or a business meeting room.

Long range wireless communications, such as cellular telephones, operate over large distances under well known standards. Europe and Asia currently use the GSM (Global Standard for Mobile communications) standard. Europe and Asia may switch in the future to W-CDMA (Wideband Code Division Multiple Access). In North America, CDMA (Code Division Multiple Access) networks may also migrate to W-CDMA. TDMA (Time Division Multiple Access) systems may migrate to EDGE (Enhanced Data rates for Global Evolution). Regardless what the standard is for long range wireless communications, we propose that new cellular telephones will have a dual transmitter and a dual receiver, one transmitter/receiver pair for long range cellular communications and the other transmitter/receiver pair for short range Bluetooth communications. Similarly, laptops, palmtops, and computer games would have a Bluetooth transmitter/receiver pair. Such devices would be considered Bluetooth capable.

The Bluetooth radio is built into a small microchip and operates in a globally available frequency band ensuring communication compatibility worldwide. The Bluetooth specification has two power levels defined; a lower power level that covers the shorter personal area within a room, and a higher power level that can cover a medium range, such as within a home. Software controls and identity coding built into each microchip ensure that only those units preset by their owners can communicate.

The Bluetooth wireless technology supports both point-to-point and point-to-multipoint connections. With the current specification, up to seven slave devices can be set to communicate with a master radio in one device. Several of these piconets can be established and linked together in ad hoc scatternets to allow communication among continually flexible configurations. All devices in the same piconet have priority synchronization, but other devices can be set to enter at any time. The topology can best be described as a flexible, multiple piconet structure.

This Bluetooth wireless technology facilitates the management of microprocessor-based technology in the localities or areas where their untimely use could be a nuisance, such as in a theatre or restaurant, a security risk, such as during a business meeting, or even dangerous, such as on an aircraft which is about to take-off or land.

### SUMMARY OF THE INVENTION

The object of the present invention is the use of wireless communications to manage the use of microprocessor-based technology. Via such a wireless communications system, microprocessor-based technology could be put to sleep during forbidden-times and allowed to operate normally during open-times.

The primary object of the invention is to create a wireless communications protocol by which wireless communications and microprocessors request permission to operate. If such permission is granted, the wireless communications and microprocessor-based technologies operates normally. However, if such permission is denied, the wireless communications and microprocessor-based technology can be put to sleep. The duration of this sleep period may be further specified by the wireless communications system.

A further object of the invention is that the wireless communications protocol could allow emergency communications to recognized emergency phone numbers, such as 911, even during the sleep or forbidden period.

In one embodiment, the invention is implemented to provide a method for a wireless communications protocol for managing wireless communication and microprocessor-based technologies. In another embodiment, the invention is implemented to provide an apparatus for a wireless communications protocol for managing wireless communication and microprocessor-based technologies. In still another embodiment, the invention is implemented to provide a signal-bearing medium tangibly embodying a program of machine-readable instructions executable by a data processing apparatus for a wireless communications protocol for managing wireless communication and microprocessor-based technologies. Finally, another embodiment consists of logic circuitry having a plurality of interconnected, electrically or optically conductive elements configured for a wireless communications protocol for wireless communication and microprocessor-based technologies.

Further objects and advantages of the invention will become apparent as the following description proceeds and the features of novelty which characterize this invention are pointed out with particularity in the claims annexed to and forming a part of this specification.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings wherein:

FIG. 1 shows a diagram of the Bluetooth protocol stack;

FIG. 2 shows a diagram of Bluetooth implemented in a wireless telephone;

FIG. 3 shows a diagram of CDMA implemented in a wireless telephone for transmission;

FIG. 4 shows a flowchart of Bluetooth implemented in a wireless telephone;

FIG. 5 shows a diagram of Bluetooth implemented in a computer device such as a laptop, palmtop, or game;

FIG. 6 shows a flowchart of Bluetooth implemented in a device such as a laptop, palmtop, or game;

FIG. 7 shows an information bearing semiconductor chip for the microcode used in the wireless management of microprocessor-based technology;

FIG. 8 shows an information-bearing cartridge;

FIG. 9 shows an information bearing storage medium for the microcode used in the wireless management of microprocessor-based technology;

FIG. 10 shows a diagram of the Bluetooth controller; and

FIG. 11 shows the input template for the Bluetooth controller.

### DESCRIPTION OF THE PREFERRED EMBODIMENTS

The Bluetooth technology was never planned to be just a physical wireless medium offering merely a platform for high-level protocols and applications. The aim is to provide something more, with immediate device interoperable as soon as the first Bluetooth products hit the market. But this can only be achieved if all the communication blocks, including radios, protocols and applications, are accurately defined and can interoperate. Bluetooth functionality is very much based on the different usage models, which formed the basis of the specification work done by the Bluetooth SIG (Special-Interest Group). These usage models have also had a great impact on the Bluetooth protocol architecture and individual protocols belonging to it.

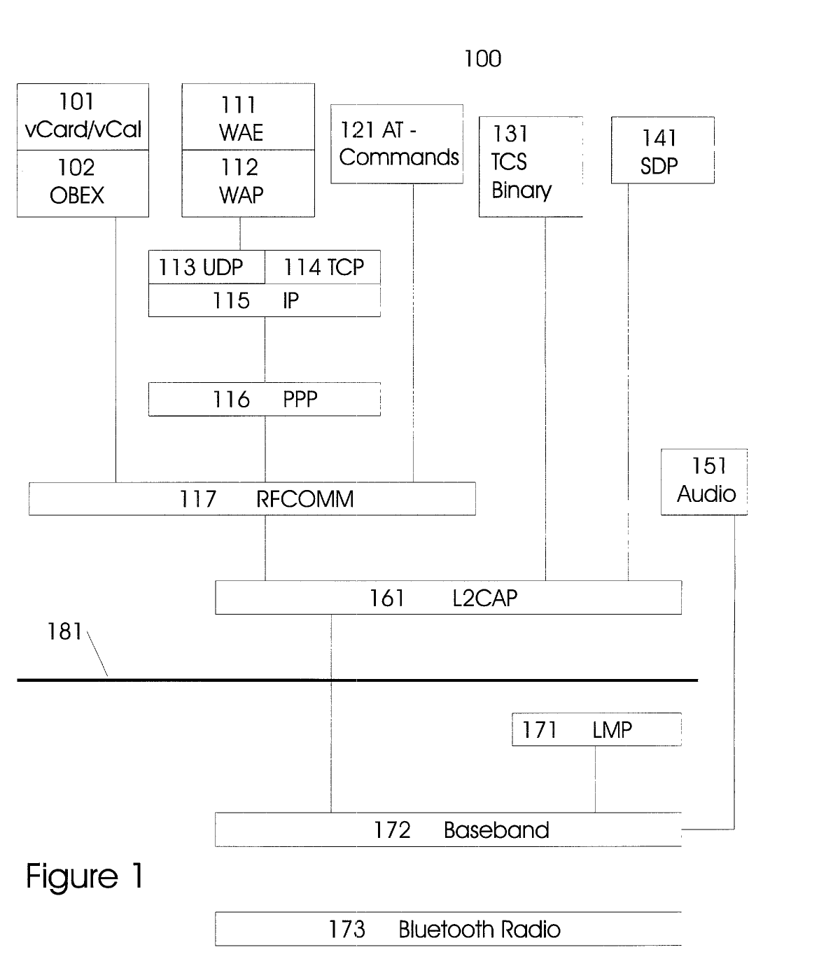

In designing the Bluetooth protocol architecture 100, FIG. 1, especially its higher layer protocols, the principle was to maximize the reuse of existing protocols for different purposes instead of reinventing, new protocols. Protocol re-use also helps software vendors to adapt existing applications to work in the wireless Bluetooth environment, as well as facilitating smooth operation of the applications and their interoperability.

To ensure rapid and widespread implementation of the Bluetooth technology, the Bluetooth Specification is open to adopter companies. This makes it possible for vendors to implement their own (proprietary) or commonly used application protocols on the top of Bluetooth-specific protocols. Different applications may run on top of different application protocols. Consequently, most applications may use different sets of protocols to achieve the desired functionality of the Bluetooth usage models. Nevertheless, each one of these different sets of protocols (i.e., vertical slices of the whole Bluetooth protocol stack) use a common Bluetooth data link and physical layer. Additional vertical slices are for services supportive of the main application, like SDP (Service Discovery Protocol) 141.

From an application viewpoint, the lower layer protocols of the Bluetooth architecture 100 are quite transparent for the applications and are shown below HCI (Host Control Interface) line 181. The Bluetooth radio aspects 173, Baseband protocol 172 and LMP (Link Manager Protocol) 171 can be categorized as lower layer protocols. Although their functionality is highly essential, many applications may not demand all of the detailed functionality on these layers.

LMP 171 is responsible for link set-up between Bluetooth devices. This includes security aspects like authentication and encryption by generating, exchanging and checking of link and encryption keys and the control and negotiation of baseband sizes. Further, LMP 171 controls the power modes and duty cycles of the Bluetooth radio device, and the connection states of a Bluetooth unit in a piconet.

Audio 151 is supported by Baseband protocol 172. Audio data can be transferred between one or more Bluetooth devices, making various usage models possible. The audio model is relatively simple within Bluetooth; any two Bluetooth devices can send and receive audio data between each other just by opening an audio link.

As regard to current Bluetooth usage models, the core of the Bluetooth protocol architecture comprises a set of three protocols—the L2CAP (Logical Link Control and Adaptation Protocol) 161, the SDP (Service Discovery Protocol) 141 and the RFCOMM protocol 117. L2CAP 161, which adapts upper layer protocols over the Baseband 172 protocol, provides connection-oriented and connectionless data services to the high layer protocols with protocol multiplexing capability, segmentation and reassembly operations, and group abstractions. L2CAP 161 permits higher level protocols and applications to transmit and receive L2CAP 161 data packets up to 64 kilobytes in length.

Device information, services and the characteristics of the services can be queried using the SDP 141. Discovery services are a crucial part of the Bluetooth framework. These services provide the basis for all the usage models. Using SDP 141, device information, services, and the characteristics of the services can be queried and after that, a connection between two or more Bluetooth devices can be established.

Like SDP 141, RFCOMM 117 is layered on top of the L2CAP 161. RFCOMM 117 is a serial line emulation protocol. As a “cable replacement” protocol, RFCOMM 117 emulates RS-232 control and data signals over the Bluetooth baseband. RFCOMM 117 also provides transport capabilities for high-level services such as the OBEX (Object Exchange) protocol 102 that use a serial line as the transport mechanism.

OBEX 102 supports the vCard and vCal(endar) applications 101, for the exchange of business cards and calendar information. OBEX 102 defines a folder-listing object, which is used to browse the contents of folders on remote devices. Currently RFCOMM 117 is the sole transport layer for OBEX 102. Future implementations of Bluetooth are likely to use TCP 114 and IP 115 as a transport for OBEX 102.

On top of the link and transport protocols, the applications still need some specific protocols to complete the protocol stack. In the Bluetooth architecture 100, the application-specific protocols are added on top of RFCOMM 117 or directly on the L2CAP 161. The object-exchange applications have been defined to use the OBEX protocol 102 on RFCOMM 117. PPP (Point-to-Point Protocol) 116, for different Internet services, is also mapped over RFCOMM 117. PPP 116 supports UDP (User Datagram Protocol) 113, TCP (Transport Control Protocol) 114, IP (Internet Protocol) 115, and WAP (Wireless Application Protocol) 112.

The architecture of WAP 112 supports WAE (WAP Application Environment) 111. Building application gateways which mediate between WAP servers and some other applications on a PC (Personal Computer) makes it possible to implement various hidden computing functionality, like remote control, data fetching from PC to handset, etc. WAP servers also allow for both content push and pull between PC and handset, bringing to life concepts like information kiosks.

AT-commands 121 and TCS (Telephony Control Specification) binary protocol 131 are used to communicate with modems and different types of phones. TCS 131 is a bit-oriented protocol, defining the call control signaling for the establishment of speech and data calls between Bluetooth devices. In addition, TCS 131 defines mobility management procedures for handling groups of Bluetooth TCS devices.

The enumerated protocols of FIG. 1 offer the basic functionality in the Bluetooth environment. More information about the Bluetooth protocols and the protocol architecture is in the Bluetooth Specification and the white papers found at http://www.bluetooth.com.

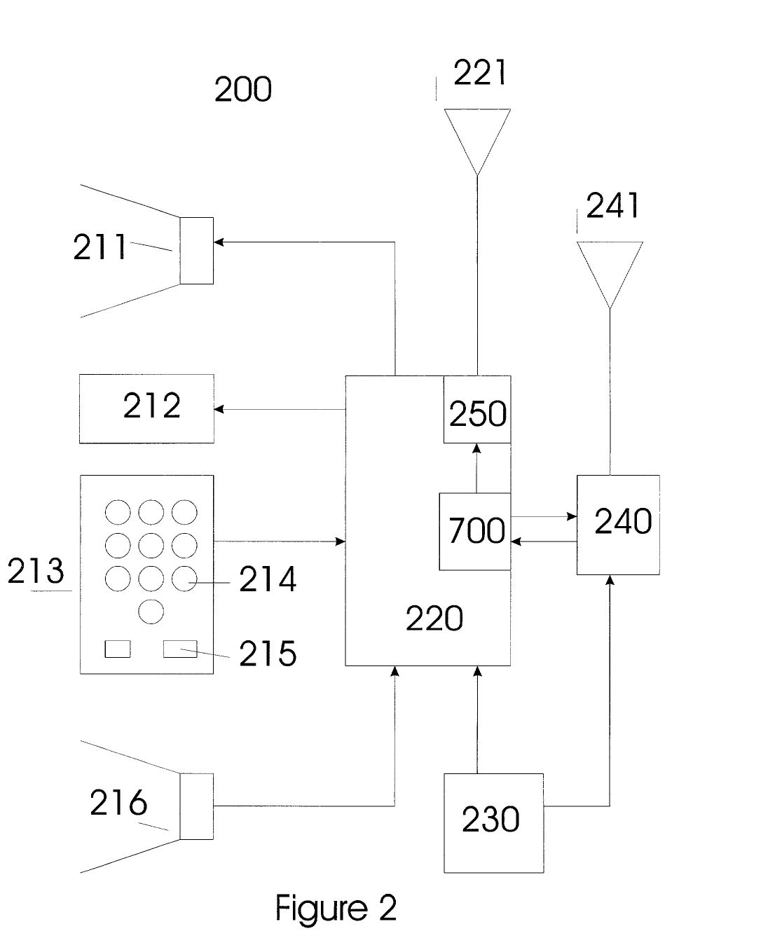

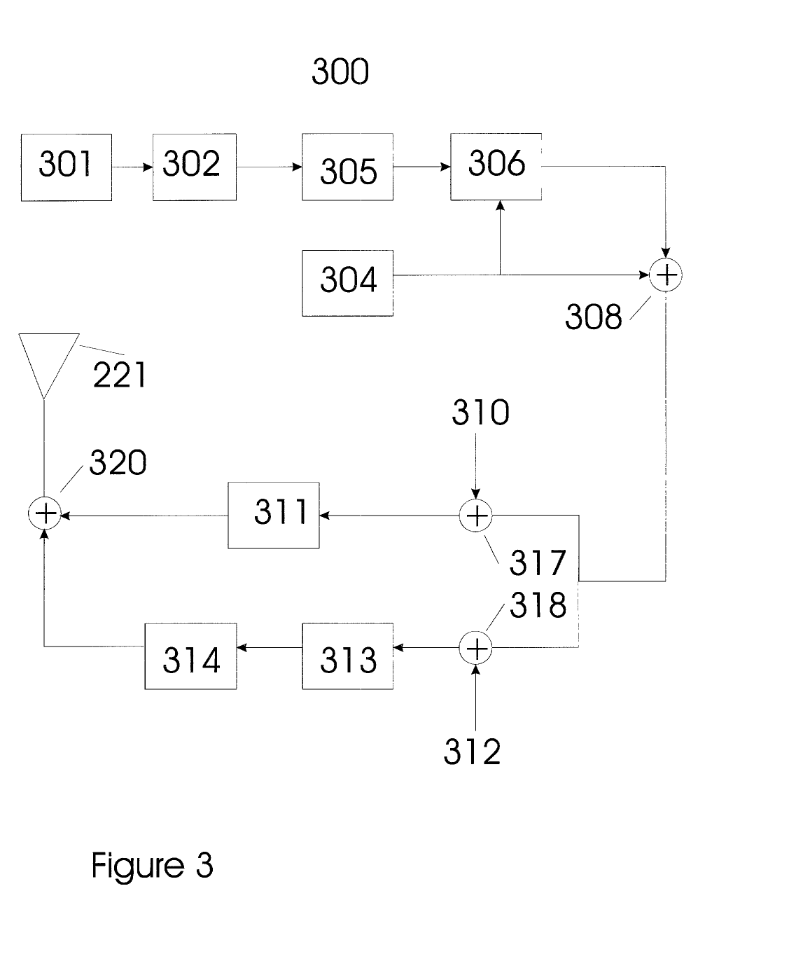

FIG. 2 shows a wireless telephone 200 which has Bluetooth implemented in it. Wireless telephone 200 has a speaker 211 which emits sound, and a microphone 216 which receives sound. Sound received by microphone 216 is converted to a signal and then transmitted by channel 220 via antenna 221. Channel 220 utilizes known techniques to process the sound received by microphone 216, such as shown in FIG. 3 for CDMA.

FIG. 3 shows process 300 for a wireless telephone transmission. Microphone 216 receives sound waves from the user and converts those sound waves into an analog electrical signal. Digitizer 301 converts that analog signal from microphone 216 into a digital information bits. Convolution encoder 302 takes the information bits from digitizer 301 and converts them to code symbols. Block interleaver 303 shifts the code symbol output of convolution encoder 302, to mitigate loss of data due to burst errors. 64-ary orthogonal modulator 304 modulates the output of block interleaver 303. Long code generator 305 sends long codes to data burst randomizer 306. Data burst randomizer 306 also receives the output of 64-ary orthogonal modulator 304. The output of data burst randomizer 306 and the long code generator 305 are then summed at summing junction 308. The output of summing junction 308 is then added with I-channel 310 at summing junction 317 and then filtered by baseband filter 311. Additionally, the output of summing junction 308 is also added with the Q-channel 312 at summing junction 318, partially delayed at delay 313, and then filtered at baseband filter 314. I-channel 310 is in-phase and Q-channel 312 is the quadrature-phase. The result of I-channel 310, Q-channel 312, and delay 313 is offset quadrature phase shift keying (OQPSK). The outputs of filters 311 and 314 are then summed at summing junction 320 and then transmitted via antenna 221.

Reception of a transmission by antenna 221 and subsequent conversion into audible sound by speaker 211 is generally the reverse process as shown in FIG. 3. The data must be detected, derandomzied, deinterleaved, decoded, and converted from digital information bits into an analog before speaker 211 converts the information into sound waves. The reception of a transmission may include a Viterbi detector for detecting and correcting of the digital information.

Wireless telephone 200 has a keypad 213 which has standard keys 214 for dialing telephone numbers. Standard keys 214 include numeral 1, numeral 2 and letters ABC, and numeral 3 and letters DEF in the first row; numeral 4 and letters GHI, numeral 5 and letters JKL, and numeral 6 and letters MNO in the second row; numeral 7 and letters PRS, numeral 8 and letters TUV, and numeral 9 and letters WXY in the third row; and numeral 0 in the fourth row. Special keys 215 may include the * key and the # key.

Wireless telephone 200 may have a display 212. Display 212 is preferably a miniature liquid crystal display. An LCD display uses organic fluids called liquid crystals, because liquid crystals possess two important properties. First, liquid crystals are transparent but can alter the orientation of polarized light passing through them. Second, the alignment of liquid crystal molecules and their polarization properties can be changed by applying an electric field. Liquid crystals are sandwiched between two glass plates, the outsides of which having been coated with polarizing filters and the inner plate is typically backlit via fluorescent light. Inside these glass plates is a matrix of electrodes. When an element of the matrix., called a pixel, experiences a voltage change, the polarization of the adjacent liquid crystal molecules change, which alters the light transmitted through the LCD pixel and hence seen by the user. However, display 212 could also be a LED (light emitting diode) display or an electroluminescent display.

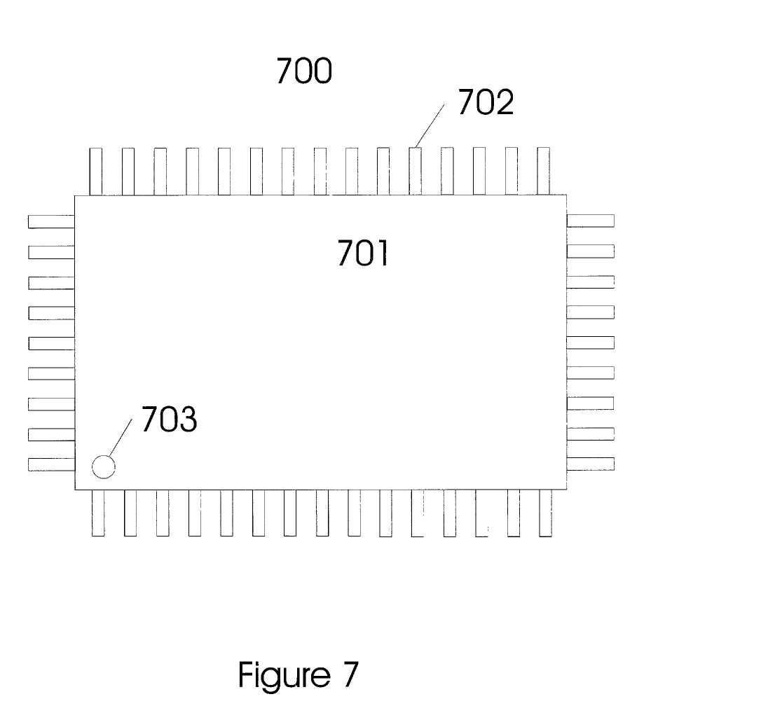

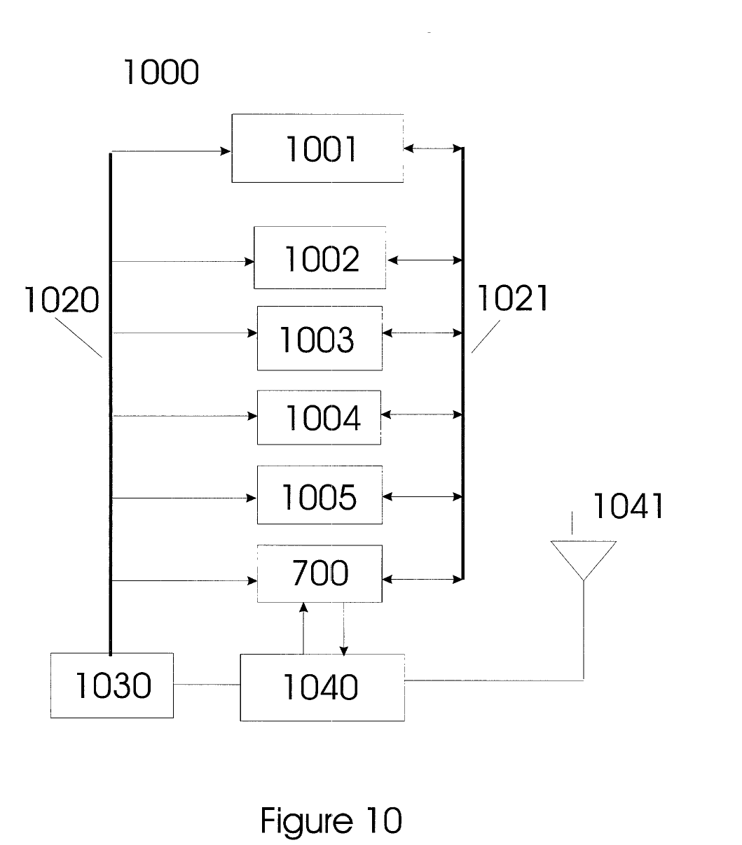

Wireless telephone 200 also has Bluetooth radio chip 240, which has its own antenna 241 for communications with Bluetooth controller 1000. Bluetooth controller 1000 is further described in FIG. 10. Bluetooth radio chip 240 is in bidirectional communication with channel 220. Channel 220 has its own internal circuitry, such as control chip 700 which is further elaborated upon in FIG. 7, to process commands received from Bluetooth radio chip 240 or to send information to Bluetooth radio chip 240. Additionally rechargeable battery 230 provides electrical power to Bluetooth radio chip 240, channel 220, and all other electrical components in wireless telephone 200.

It should be noted that control chip 700 controls on/off circuit 250. When switched on, circuit 250 would allow wireless telephone 200 to originate or receive long-range wireless communications. When switched off, circuit 250 would prevent wireless telephone 200 from originating or receiving long-range wireless communications. Although on/off circuit 250 is shown in its preferred position of controlling signals to or from antenna 221, on/off circuit 250 could be located in many other strategic locations in wireless telephone 200. Such alternate strategic locations in wireless telephone 200 could include controlling electrical power from battery 230 to channel 220, keyboard 213, or microphone 216 and speaker 211. Even when open wireless communication is prohibited by Bluetooth controller 1000, it is possible that computer chip 700 would allow certain telephone numbers to be dialed on a highly selective basis, such as the 911 emergency number.

On/off circuit 250 is preferably a power transistor. Examples of power transistors are LM195, LM395, and LP395; which are manufactured by National Semiconductor Corporation. These power transistors directly interface with CMOS (Complementary Metal-Oxide Semiconductor) or TTL (Transistor to Transistor Logic) signals from control chip 700.

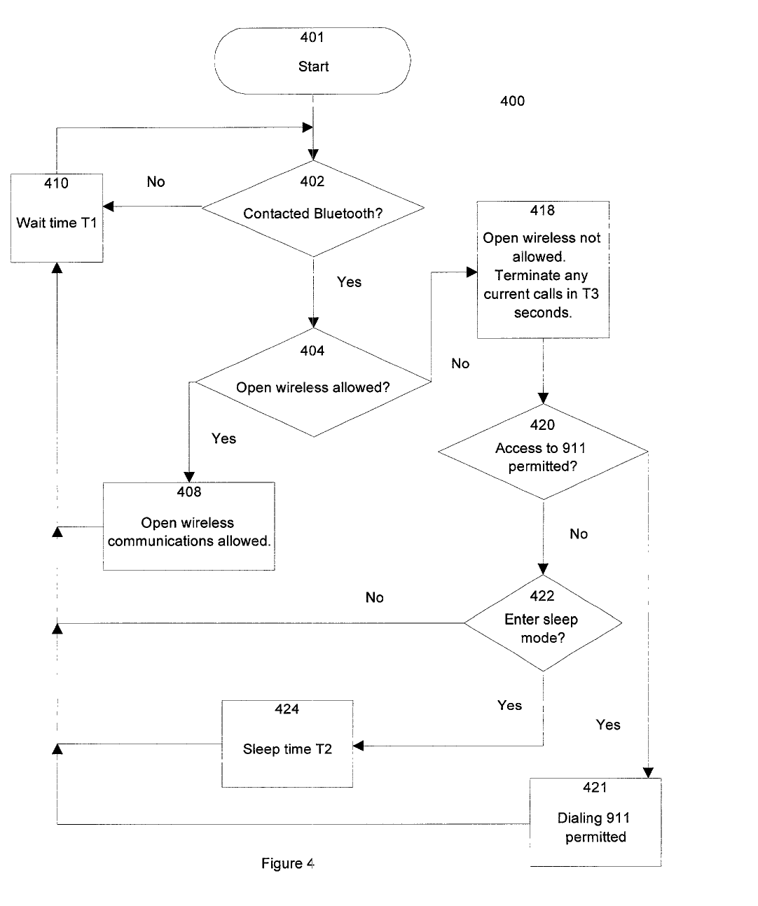

FIG. 4 shows a flow chart 400 for the control of wireless telephone 200 by Bluetooth. The process begins at step 401, when the telephone is first turned on. In step 402, process asks whether wireless telephone 200 has been contacted or has itself contacted a Bluetooth controller 1000. If not, the process flows from step 402 to step 410, where the wireless telephone 200 waits time period T1 before recontacting Bluetooth controller 1000 in step 402. During this time, wireless telephone 200 continues to execute its previous instructions. In the absence of any contact with Bluetooth controller 1000, the default instruction would be to allow open wireless communications. Time period T1 could vary between a very short time interval of 15 seconds and a significantly longer time interval of 10 or more minutes.

If a Bluetooth controller 1000 was contacted in step 402, the process flows to step 404, where Bluetooth establishes whether or not open wireless communication is allowed. If yes, the process flows to step 408 where open wireless communication is fully allowed by control chip 700 via control of on/off circuit 250. During this period of open wireless communications, the process flows to step 410, where wireless telephone 200 waits time period T1 before attempting to recontact a Bluetooth controller 1000.

If in step 404, open wireless communications is not allowed, the process flows to step 418 where open wireless communications are not allowed by control chip 700 via control of on/off circuit 250. The user has T3 seconds to complete his or her conversation before on/off circuit 250 is switched to the off position. Time T3 may range from 10 to 60 seconds. From step 418, the process flows to step 420, where access to an emergency telephone number such as 911 is determined. If yes, the process flows to step 421 where dialing 911 is permitted. From step 421, the process goes back to step 410. If access to an emergency telephone number such as 911 is denied in step 420, the process flows to step 422. In step 422, Bluetooth controller 1000 has sent instructions as to whether to put wireless telephone 200 to sleep. If in step 422 the answer is yes, the process flows to step 424 where wireless telephone 200 is put to sleep for time period T2. Time period T2 is typically longer than time period T1. Time period T2 may range from 5 minutes to up to several hours during a transatlantic flight or over 12 hours for a flight crossing the Pacific ocean. After pausing to sleep at step 424 for time T2, the process flows to step 410. If on the other hand, if the answer to entering a sleep mode is no in step 422, the process flows to step 410 directly without entering a sleep mode.

Bluetooth controller 1000 may specify that wireless telephone 200 announce to its user the status of whether open wireless communications were allowed; whether access to the emergency 911 telephone number is allowed; whether the wireless telephone 200 would be put to sleep and for how long; and if the user has to hang up, how much time the user has to do so.

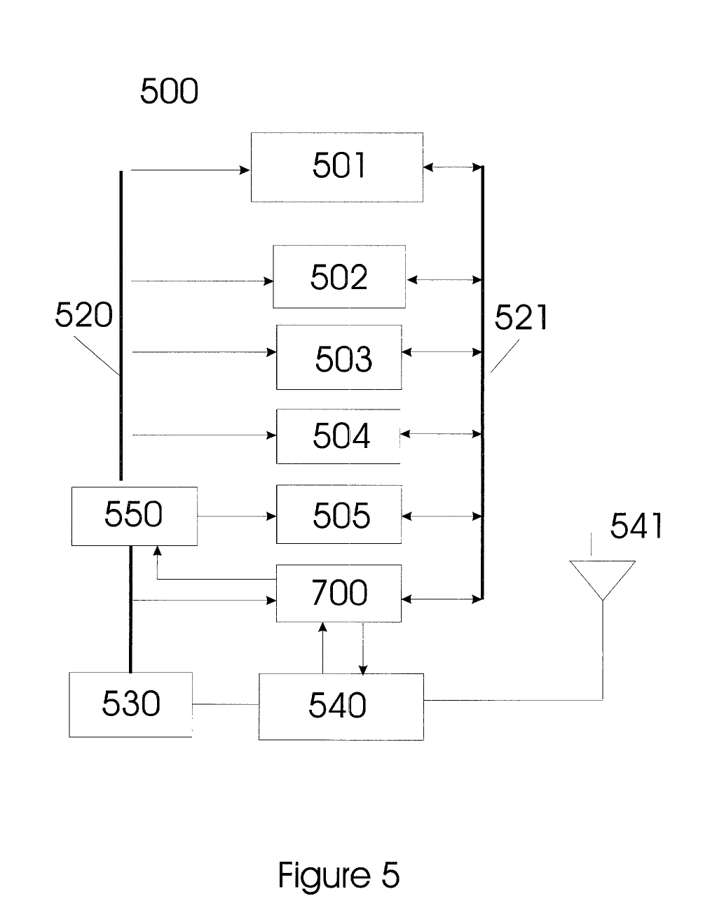

FIG. 5 shows computer 500. Computer 500 may be a personal computer (PC), desktop computer, laptop computer, palmtop, or game such as Nintendo. Computer 500 has microprocessor 501 and memory 502. Memory 502 may be random access memory (RAM) or erasable programmable read only memory (EPROM). Computer 500 typically has a display 503. Display 503 may be liquid crystal device. However, display 503 could also be a LED (light emitting diode) display or an electroluminescent display. Although typically an output device, display 503 may be a touch-screen and thus capable of providing input to computer 500. Additionally, computer 500 may have a dedicated input device 504 such as a keyboard or a mouse, as well as an I/O device 505, such as a floppy disk drive, a CD-ROM drive, or a DVD drive.

Computer 500 also has Bluetooth radio chip 540, which has its own antenna 541 for communications with Bluetooth controller 1000. Bluetooth radio chip 540 is in bidirectional communication with control chip 700 which is further elaborated upon in FIG. 7, to process commands received from Bluetooth radio chip 540 or to send information to Bluetooth radio chip 540.

Via power bus 520, power supply 530 supplies electrical power to microprocessor 501, memory 502, display 503, dedicated input device 504, I/O device 505, as well as to Bluetooth radio chip 540 and control chip 700.

It should be noted that control chip 700 controls on/off circuit 550. When switched on, circuit 550 would allow computer 500 to process data or play games. However, once switched off, circuit 550 would prohibit activity on computer 500. On/off circuit 550 is preferably a power transistor. Examples of power transistors are LM195, LM395, and LP395; which are manufactured by National Semiconductor Corporation. These power transistors directly interface with CMOS or TTL signals from control chip 700.

Computer 500 also has data bus 521, which allows bidirectional communications between microprocessor 501 and memory 502, display 503, dedicated input device 504, I/O device 505, and control chip 700. Thus, when Bluetooth radio 540 receives instructions that activity on computer 500 is forbidden, control chip 700 can send instructions to microprocessor 510 to stop processing data and save all calculations to memory 502 or I/O device 505 before shutting down computer 500.

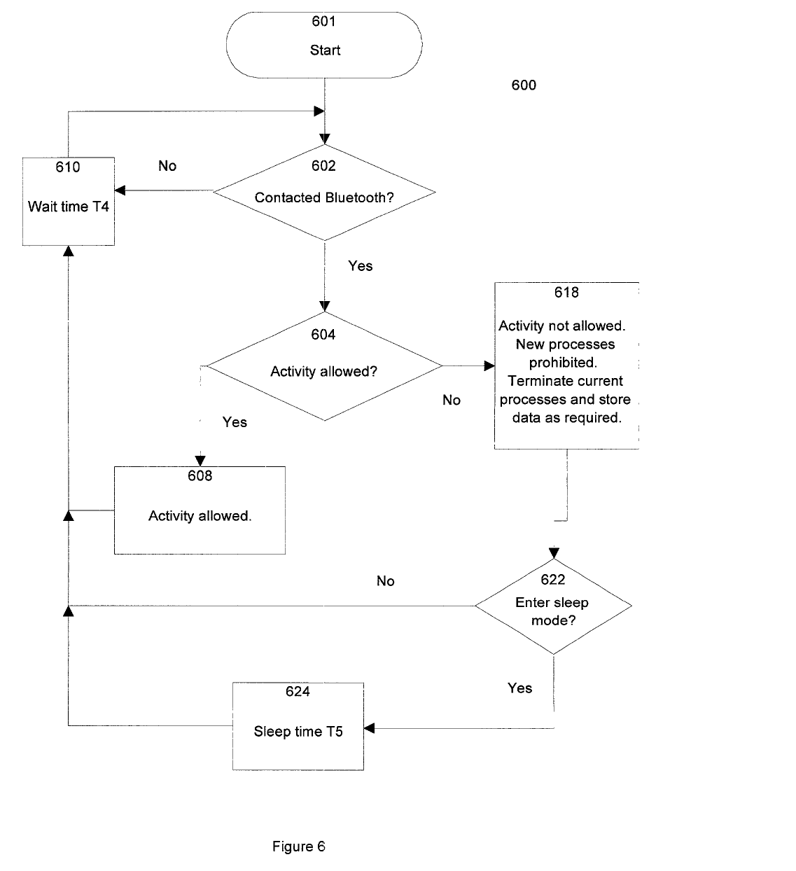

FIG. 6 shows a flow chart 600 for the control of a computer, laptop, palmtop, or game 500 by Bluetooth. The process begins at step 601, when computer 500 is first turned on. In step 602, process asks whether computer 500 has been contacted or has itself contacted a Bluetooth controller 1000. If not, the process flows from step 602 to step 610, where computer 500 waits time period T4 before recontacting Bluetooth in step 602. Time period T4 could vary between a very short time interval of 15 seconds and a significantly longer time interval of 10 or more minutes. Time period T4 in FIG. 6 may equal time period T1 in FIG. 4, as a matter of programming convenience.

If a Bluetooth controller was contacted in step 602, the process flows to step 604, where Bluetooth establishes whether or not activity is allowed on computer 500. If yes, the process flows to step 608 where activity is allowed by control chip 700 via control of on/off circuit 550, or by explicit instructions given to microprocessor 501. During this activity, the process flows to step 610, where computer 500 waits time period T4 before attempting to recontact a Bluetooth controller 1000. During this time, computer 500 continues to execute its previous instructions. In the absence of any contact with Bluetooth controller 1000, the default instruction would be to allow microprocessor activity.

If in step 604, activity is not allowed, the process flows to step 618 where activity is not allowed by control chip 700 via either commands directly to microprocessor 601 and/or control of on/off circuit 550. Computer 500 would be instructed to stop processing data and to save required data in memory 502 or I/O device 505 before shutting down. From step 618, the process flows to step 622. In step 622, Bluetooth has sent instructions as to whether to put computer 500 to sleep. If in step 622 the answer is yes, the process flows to step 624 where computer 500 is put to sleep for time period T5 via either commands directly to microprocessor 601 and/or control of on/off circuit 550. Time period T5 is typically longer than time period T4. Time period T5 may range from 5 minutes to up to several hours. After pausing to sleep at step 624 for time T5, the process flows to step 610. If on the other hand, if the answer to entering a sleep mode is no in step 622, the process flows to step 610 directly without entering a sleep mode.

Bluetooth controller 1000 may specify that computer 500 print a message on display 503 to its user the status of whether microprocessor activity is allowed and whether the computer 500 would be put to sleep, as well as for how long.

FIG. 7 shows control chip 700 which would store the algorithms in FIGS. 4 and 6, as well as all necessary Bluetooth related microcode instructions. Control chip 700 may be a RAM, an EPROM, or an ASIC chip, etc. The exterior of chip 700 shows a typically square or rectangular body 701 with a plurality of electrical connectors 702 along the perimeter of body 701. There is typically an alignment dot 703 at one corner of chip 700 to assist with the proper alignment of chip 700 on a card. Within body 701, chip 700 consists of a number of interconnected electrical elements, such as transistors, resistors, and diodes. These interconnected electrical elements are fabricated on a single chip of silicon crystal, or other semiconductor material such as gallium arsenide (GaAs) or nitrided silicon, by use of photolithography. One complete layering-sequence in the photolithography process is to deposit a layer of material on the chip, coat it with photoresist, etch away the photoresist where the deposited material is not desired, remove the undesirable deposited material which is no longer protected by the photoresist, and then remove the photoresist where the deposited material is desired. By many such photolithography layering-sequences, very-large-scale integration (VLSI) can result in tens of thousands of electrical elements on a single chip. Ultra-large-scale integration (ULSI) can result in a hundred thousand electrical elements on a single chip.

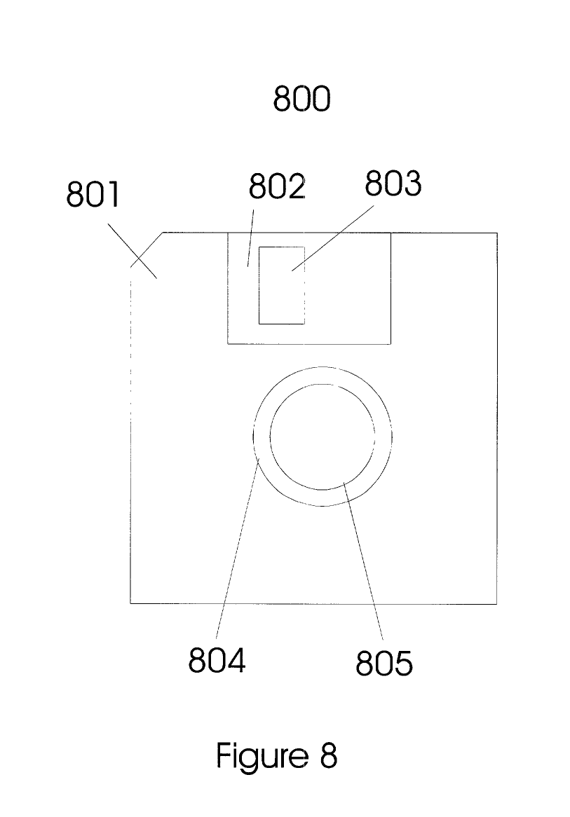

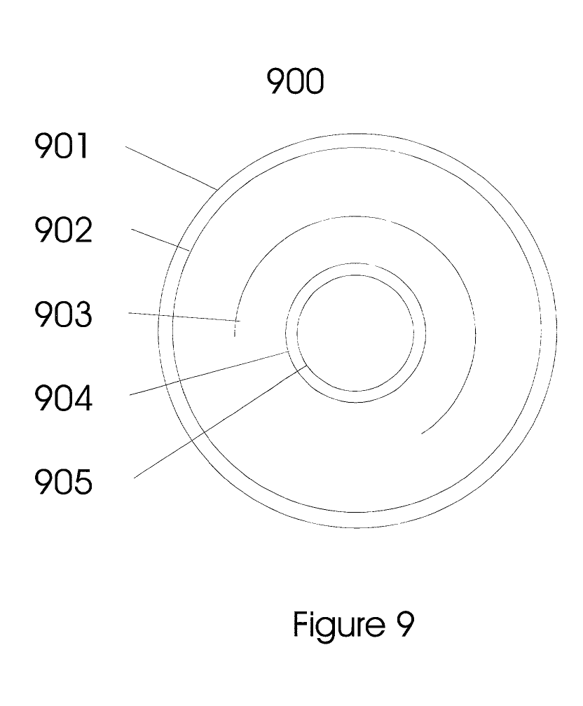

FIG. 8 shows a typical disk cartridge 800 which could be used hold the microcode used in processing Bluetooth instructions. Disk cartridge 800 consists of cartridge body 801 and shutter 802. Shutter 802 has an opening 803, so that I/O can be performed on the data on disk 900 inside of the cartridge body 801. Additional information about disk 900 is provided in FIG. 9. Cartridge body 801 has an opening 804 so that the hub 805 of the disk 900 can be rotated by a disk drive, for the purposes of I/O. The disk 900 inside of cartridge 800 could be an optical DVD (Digital Versatile Disk), an optical CD-ROM disk, a magneto-optical disk, a hard disk such as used in Iomega's Jaz drive, or a floppy disk, such as used in lomega's Zip drive.

FIG. 9 shows a typical floppy disk 900 which could be contained in disk cartridge 800, but need not be contained in cartridge 800. Disk 900 has an circular outer perimeter 901. The algorithms such as in FIGS. 4 and 6, as well as all necessary Bluetooth related microcode instructions would be recorded in circular or spiral tracks 903 between the inner data radius 904 and the outer data radius 902. Hub 905 may be used to rotate the disk 900 so that I/O can be performed on the data in tracks 903.

FIG. 10 shows Bluetooth controller 1000. Bluetooth controller 1000 may be a personal computer (PC), desktop computer, laptop computer, or palmtop. Bluetooth controller 1000 has microprocessor 1001 and memory 1002. Memory 1002 may be random access memory (RAM) or erasable programmable read only memory (EPROM). Bluetooth controller 1000 typically has a display 1003. Display 1003 may be liquid crystal device. However, display 1003 could also be a LED (light emitting diode) display or an electroluminescent display. Although typically an output device, display 1003 may be a touch-screen and thus capable of providing input to Bluetooth controller 1000. Additionally, Bluetooth controller 1000 may have a dedicated input device 1004 such as a keyboard, mouse or voice recognition system, as well as an I/O device 1005, such as a floppy disk drive, a CD-ROM drive, or a DVD drive.

Bluetooth controller 1000 also has Bluetooth radio chip 1040, which has its own antenna 1041. Bluetooth radio chip 1040 is in bidirectional communication with control chip 700, to process commands received from Bluetooth radio chip 1040 or to send information to Bluetooth radio chip 1040.

Via power bus 1020, power supply 1030 supplies electrical power to microprocessor 1001, memory 1002, display 1003, dedicated input device 1004, I/O device 1005, as well as to Bluetooth radio chip 1040 and control chip 700.

Bluetooth controller 1000 also has data bus 1021, which allows bidirectional communications between microprocessor 1001 and memory 1002, display 1003, dedicated input device 1004, I/O device 1005, and control chip 700.

Bluetooth controller 1000 has a range of about 10 meters or 30 feet. Bluetooth controller 1000 would be placed in the center or other strategic locations in a restaurant, theater, meeting room, or aircraft for the express purpose of controlling the communications and microprocessor activity in those structures. Bluetooth controller 1000 can control wireless communications and microprocessor based activity separately. This control is essential for safety reasons, during aircraft takeoff and landing; for security reasons, during business meetings; and for politeness and courtesy, during meals at a restaurant or performances at a theater. This control would preferably use Bluetooth and TCS (Telephony Control Specification) binary protocol 131. However, other Bluetooth protocols shown in FIG. 1 could equally be used, such as WAP (Wireless Application Protocol) 112 or RFCOMM 117.

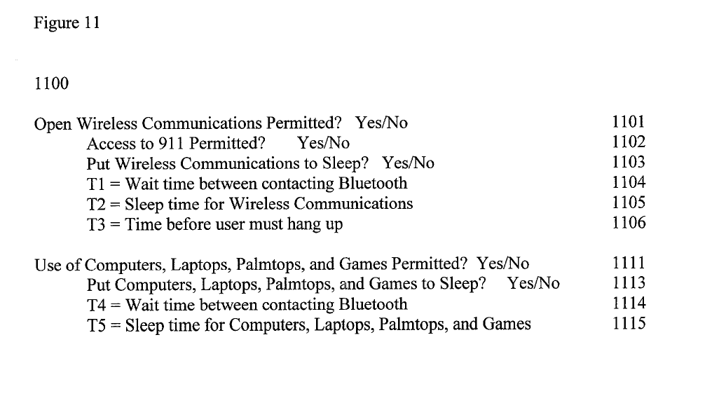

Via the template 1100 shown in FIG. 11, which would be displayed on display 1003, the user of Bluetooth controller 1000 can change the status of whether wireless communications are allowed 1101 and whether microprocessor activity in computers, laptops, palmtops, and games is allowed 1111. Input to template 1100 could come from touchscreen display 1003, dedicated input device 1004 such as a keyboard, mouse or voice recognition system, as well as an I/O device 1005, such as a floppy disk drive, a CD-ROM drive, or a DVD drive.

If wireless communications is not allowed 1101, the user of Bluetooth controller 1000 can decide whether to allow access to the emergency 911 number or its equivalents 1102. The user of Bluetooth controller 1000 can also decide whether to put all wireless communications to sleep 1103. Then the user of Bluetooth controller 1000 can set values for times T1 1104, T2 1105, and T3 1106.

If microprocessor activity in computers, laptops, palmtops, and games is not allowed 1111, the user of Bluetooth controller 1000 can decide whether to put all microprocessor based computers, laptops, palmtops, and games to sleep 1113. Finally the user of Bluetooth controller 1000 can set values for times T4 1114 and T5 1115.

While the invention has been shown and described with reference to a particular embodiment thereof, it will be understood to those skilled in the art, that various changes in form and details may be made therein without departing from the spirit and scope of the invention.

What I claim is:

1. An apparatus for controlling the use of a wireless telephone, said wireless telephone having a speaker, a microphone, a channel, a first antenna, and a power source, said apparatus comprising:
an external controller, said external controller having a range of control;
a second antenna, said second antenna in said wireless telephone, said second antenna capable of receiving signals from said external controller;
a radio, said radio in electrical communication with said second antenna;
a control chip, said control chip in electrical communication with said radio; and
an on/off switch, said on/off switch in electrical communication with said control chip, whereby said external controller can control the use of said wireless telephone within the range of control.

2. The apparatus for controlling the use of a wireless telephone, as in claim 1, further comprising:
said radio and said external controller utilize a Bluetooth protocol.

3. The apparatus for controlling the use of a wireless telephone, as in claim 1, further comprising:
said on/off switch electrically interposed between said channel and said first antenna.

4. The apparatus for controlling the use of a wireless telephone, as in claim 1, further comprising:
said on/off switch electrically interposed between said power source and said channel.

5. A method for controlling a wireless telephone, comprising the machine executed steps of:
contacting an external controller;
receiving instructions from an external controller; and
changing the status of an on/off switch.

6. A program storage device readable by a wireless telephone, tangibly embodying a program of instructions executable by said wireless telephone, to perform method steps for operating wireless telephone, comprising the machine executed steps of:
contacting an external controller;
receiving instructions from an external controller; and
changing the status of an on/off switch.

7. A logic array readable by a computer, tangibly embodying a program of instructions executable by said wireless telephone, to perform method steps for operating wireless telephone, comprising the machine executed steps of:
contacting an external controller;
receiving instructions from an external controller; and
changing the status of an on/off switch.

8. An apparatus for controlling the use of a computer, said computer having a microprocessor, a display, a memory, and a power source, said apparatus comprising:
an external controller, said external controller having a range of control;
an antenna, said antenna in said computer, said antenna capable of receiving signals from said external controller;
a radio, said radio in electrical communication with said antenna;
a control chip, said control chip in electrical communication with said radio; and
an on/off switch, said on/off switch in electrical communication with said control chip, whereby said external controller can control the use of said computer within the range of control.

9. The apparatus for controlling the use of a computer, as in claim 8, further comprising:
said radio and said external controller utilize a Bluetooth protocol.

10. The apparatus for controlling the use of a computer, as in claim 8, further comprising:
said on/off switch electrically interposed between said power source and said microprocessor.

11. A method for controlling a computer, comprising the machine executed steps of:
contacting an external controller;
receiving instructions from an external controller;
changing the status of an on/off switch.

12. A program storage device readable by a computer, tangibly embodying a program of instructions executable by said computer, to perform method steps for operating a liquid crystal projector for the display of images on an external screen, comprising the machine executed steps of:
contacting an external controller;
receiving instructions from an external controller; and
changing the status of an on/off switch.

13. A logic array readable by a computer, tangibly embodying a program of instructions executable by a computer, to perform method steps for operating a liquid crystal projector for the display of images on an external screen, comprising the machine executed steps of:
contacting an external controller;
receiving instructions from an external controller; and
changing the status of an on/off switch.
